(19) United States
(12) Patent Application Publication
(10) Pub. No.: US 2011/0278225 A1
(43) Pub. Date: Nov. 17, 2011

(54) METHOD FOR PURIFYING WATER BY CYCLIC IONIC EXCHANGE

(75) Inventor: Francis Boodoo, King of Prussia, PA (US)

(73) Assignee: BROTECH CORP., D/B/A THE PUROLITE COMPANY, Bala Cynwyd, PA (US)

(21) Appl. No.: 13/096,406

(22) Filed: Apr. 28, 2011

Related U.S. Application Data
(60) Provisional application No. 61/330,737, filed on May 3, 2010.

(51) Int. Cl. C02F 1/42; B01D 61/14; C02F 1/44

(52) U.S. Cl. 210/636; 210/638

(57) ABSTRACT

The present invention provides a method for purifying or softening water comprising: passing a specific volume of feedwater through at least one service column comprising a strong acid cationic exchange resin capable of binding divalent cations that are present in the feedwater, wherein the loading of the divalent cations on the resin is restricted to about 1 to 25% of the available ion exchange sites on the resin, and the total dissolved solids in the feedwater is greater than 100 mg/l; feeding the water exiting the service column to a reverse osmosis membrane or a nanofiltration membrane to produce permeate water stream and a reject water stream; and passing all or some of the volume of the reject stream corresponding the specific volume of feedwater through at least one off-line column capable of binding monovalent cations; wherein the chemical equivalent ratio of monovalent to divalent cations in the water exiting the service column is greater than 20 to 1; wherein no external source of regenerant salt is used. The inventive method allows for multiple softening/regeneration cycles so that steady state hardness leakage is achieved that is lower than obtainable with conventional ion exchange softening systems.

### FIELD OF THE INVENTION

The present invention relates generally to the purification of water containing soluble and sparingly soluble inorganic compounds. In particular, the present invention provides water purification methods using a unique reprocessing of ionic exchange softened water which is applied to reverse osmosis or nanofiltration membrane systems. Ultra-low concentrations of brines rejected from membrane plants are used to effectively regenerate ion exchange softening resins in a self-sustaining manner without supplemental salt addition.

### BACKGROUND OF THE INVENTION

Sparingly soluble divalent cations such as calcium, magnesium, and barium are commonly found in feed water streams (e.g., brackish or semi-brackish feed water streams) which are applied to reverse osmosis (RO) and nanofiltration (NF) systems during water treatment processes. Although RO and NF filtration provide effective and economically viable methods for purifying water, these membrane processes are often disrupted by scale formation where the divalent cations present in the feed water precipitate as scale on the surface of the membranes as the concentrations of these compounds are increased beyond their saturation values. Deposition of insoluble inorganic salts frequently results in a loss of permeate water production due to blockage of membrane flow channels and increased pressure drop across membranes, causing the eventual need for costly replacement and cleaning of the RO membranes.

A variety of scale control methods can be used to reduce insoluble inorganic contaminants in order to improve water recovery and prevent scale formation. For example, calcium carbonate scaling may be treated by adding an inorganic acid (e.g. sulfuric or hydrochloric acid) into the feedwater. The acid neutralizes bicarbonate alkalinity in the influent water and prevents carbonate salts from precipitating on the membranes. For large RO plants, pretreatment of feedwater can involve use of a chemical precipitator system, dosing a variety of chemicals such as lime, magnesium oxide and sodium carbonate. Antiscalant formulations also may be added to the feedwater to hinder precipitation of scaling compounds and control other potential foulants such as iron, manganese, aluminum and silica. Combinations of acid and antiscalant dosing can provide superior control. However, each of these methods have their limitations in terms of targeting individual contaminants or in terms of the level of skilled labor need to operate, or the need to handle hazardous chemicals.

An alternative method for softening water involves treatment with an ion exchange resin. In particular, strong acid cation exchange resins can be used to reduce the amount of divalent cations present in the water to low μg/l concentration. Purification by ion exchange involves transfer of soluble impurities to the resin bed. Once the binding sites of the resin have been saturated, the column can be regenerated using, for example, a highly concentrated brine solution to strip the resin of the bound impurities. However, the large amount of soluble salt that is needed for effective regeneration of cationic resin is costly, and large waste volumes are produced during the regeneration step. For these reasons, conventional ion exchange is not ideal or suitable for large scale purification of water.

Conventional ion exchange softeners require 10% brine (sodium chloride) solution for periodic regeneration of the ion exchange resin once the binding affinity of the resin for divalent cations has reached capacity. In order to achieve the lowest possible hardness leakage from the softener, the salt dose used for regeneration of the resin is generally in excess over the available resin binding sites. As illustrated in FIG. 1, the regeneration step is optimized when the brine concentration of the regenerant is 10%. Importantly, the exchange capacity of the softening resin falls off significantly at low brine concentrations.

Strong acid cation resin can be repeatedly used for softening water due to the principles of “reversal of selectivity.” Specifically, under dilute conditions where the total dissolved solids (TDS) of the water is relatively low, the resin shows high selectivity for divalent cations over monovalent cations, and preferentially binds calcium and magnesium over sodium. In contrast, under concentrated conditions in which the TDS of the solution is relatively high, the resin exhibits low selectivity for divalent cations. Hence when a 10% brine solution is used to regenerate the resin, elution of divalent cations in place of sodium is quite efficient. Elution of divalent cations becomes increasingly difficult as the brine concentration or TDS approaches that of the feedwater.

The concentrate stream of water from a RO system contains a dilute brine (i.e., sodium cation) concentration that is similar to that of natural water. Efficient methods using dilute brine as a regenerant for a cation exchange water softener is very desirable, especially if supplemental salt addition can be avoided.

Lindsay et al. (Powell, Sheppard T., Water Conditioning for Industry, 1954, McGraw Hill, pp. 154-155) discloses that the operating capacity of resin regeneration is substantially inhibited at brine concentrations of 2.7% and 0.75%. Brine concentrations of 0.75% reduce regeneration efficiency by 70% compared to that achieved with 10% brine regenerants.

U.S. Pat. No. 3,639,231 (Bresler et al.) discloses that a brine concentration of 1.23% comprising the RO reject stream was used to regenerate a cationic exchange resin. Hardness leakage was measured at 9 ppm, whereas the hardness leakage for good scale control in modern membranes without the supplemental use of scale inhibitor chemicals is typically less than 1 ppm hardness.

Everest et al. (Everest, W. R., Watson, I. C., Maclain, D., Elsevier, Desalination (1998) 117:197-202) discloses that RO concentrate alone is insufficient to effectively regenerate the softeners and that supplemental salt addition is needed for sufficient purification.

Tokmachev et al. (Reactive Functional Polymers 68 (2008) Elsevier, pp 1245-1252 describes a self-sustaining cyclic softening process for sea water using the concentrate stream from the bottom of an evaporator unit to regenerate an ion exchange softener that pretreated the sea water before it was fed to the evaporator. The brine concentration used was approximately 0.9 moles/liter of sodium (approximately 5%), which is near the optimum 10% brine concentration used by industry.

U.S. Pat. No. 6,461,514 (Samadi et al.) discloses ion exchange softening of a concentrate stream from a first stage RO before feeding the softened concentrate to a second stage RO. The concept of inter-stage softening is said to maximize water recovery from the plant. However, Samadi et al. makes no attempt to use the RO concentrate to regenerate the resin but instead uses the conventional method of regeneration using costly commercial salt brine solution.

U.S. Patent Application Publication 2010/0282675 (SenGupta et al.) describes a self-sustaining ion exchange process for membrane desalination of sea water. In particular, the osmotic pressure of the feed water is reduced by pretreating feed water with a strong acid cation resin in magnesium form where sodium and calcium cations present in the sea water are partially exchanged for magnesium. The reduction in monovalent sodium cations and replacement with divalent magnesium cations is said to permit reduction in the osmotic pressure of the water.

Conventional methods for resin regeneration promote the use of high brine concentrations because low concentrations of brine (e.g. 0.75%) yields low regeneration efficiency (e.g. 0.75% brine reduces regeneration efficiency by 70%), and can require, for example, at least three times as much commercial salt and at least ten times the amount of water to make up the brine solution.

Thus, there is a pressing need for a cost effective and environmentally friendly method for regenerating ion exchange softeners using dilute brine solutions such as those typically present in the RO and NF membrane reject streams. Methods for achieving hardness leakage of less than 1 mg/l, without supplemental salt addition are particularly desirable.

### SUMMARY OF THE INVENTION

An object of the invention is to provide at least a partial solution to the above-described problems and/or disadvantages in the prior art by providing a self-sustaining cyclic ionic exchange method for regenerating cationic exchange resins using the dilute brine solution present in the RO or NF reject streams.

Accordingly, one embodiment of the invention is directed to a self-sustaining method of purifying water comprising:

a) passing a specific volume of feedwater containing both mono and divalent cations through at least one service column comprising a cationic exchange resin with a substantial fraction of its ion exchange sites in the monovalent form and capable of binding divalent cations that are present in the feedwater, wherein the loading of the divalent cations on the resin is restricted to about 1 to 25% of the available ion exchange sites on the resin, and the total cation concentration of the feedwater is greater than 100 mg/l;

b) feeding the water exiting the service column to a reverse osmosis membrane or a nanofiltration membrane to produce a permeate water stream and a reject water stream, with the reject stream containing a major fraction of the monovalent cations present in the effluent from the service column; and

c) passing all or some of the volume of the reject stream corresponding to the specific volume of feedwater through at least one off-line column capable of binding monovalent cations;

wherein the chemical equivalent ratio of monovalent to divalent cations in the water exiting the service column is greater than 20 to 1.

d) switching at least one service column to the offline mode and switching at least one offline column to the service mode and repeating steps (a) to (c) multiple times in order to achieve steady-state leakage concentrations of the divalent cations in the water exiting the service column.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

Non-limiting and non-exhaustive embodiments of the present invention are described with reference to the following drawings. For a better understanding of the present invention, reference will be made to the following Detailed Description, which is to be read in association with the accompanying drawings, wherein:

FIG. 1 is a schematic showing the impact of brine concentration on the regeneration efficiency of a cationic exchange resin.

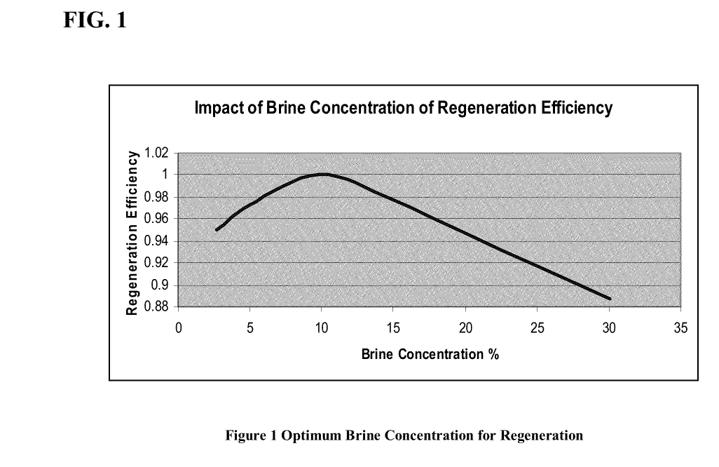

FIG. 2 illustrates a cyclic ion exchange process wherein a feedwater is applied to a strong acid cation resin “service column” prior to reverse osmosis. The reject water serves as a “brine regenerant” and is applied to a strong acid cation resin “off-line column” in the column regeneration step.

FIG. 3 illustrates the calculated separation factor for calcium versus brine concentration for a strong acid cationic exchange resin.

FIG. 4 depicts the impact of the service cycle volume or “bed volume” (BV) on steady-state total hardness leakage (TH) from a cationic exchange resin.

FIG. 5 illustrates the impact of bed utilization or hardness loading on hardness leakage (TH) from a cation exchange resin.

FIG. 6 illustrates the impact of modulating hardness leakage (TH) by controlling service cycle volume (BV).

FIG. 7 illustrates an “inter-stage” cyclic ion exchange-reverse osmosis process in which the reject brine from the first stage of a dual stage reverse osmosis plant is applied to a strong acid cation resin “service column” prior to a second stage. The reject water from the second stage of the reverse osmosis plant serves as a “brine regenerant” and is applied to a strong acid cation resin “off-line” column in the column regeneration step.

FIG. 8 illustrates sodium content of 0.5% RO reject brine used for column regeneration.

FIG. 9 illustrates softening capability of the CIX-RO process over multiple softening cycles using 0.5% RO reject brine.

FIG. 10 illustrates sodium content of 0.2% RO reject brine used for column regeneration.

FIG. 11 illustrates softening capability of the CIX-RO process over multiple softening cycles using 0.2% RO reject brine.

FIG. 12 illustrates sodium content of 0.1% RO reject brine used for column regeneration.

FIG. 13 illustrates softening capability of the CIX-RO process over multiple softening cycles using 0.1% RO reject brine.

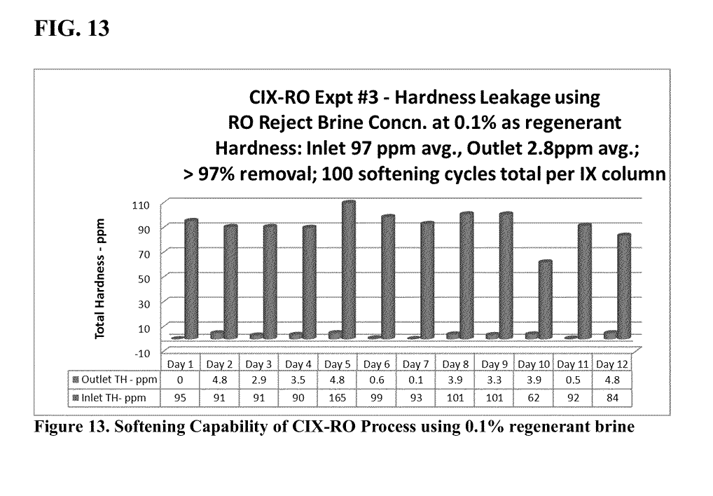

### DETAILED DESCRIPTION

It is understood that the invention(s) described herein is (are) not limited to the particular methodologies, protocols, and reagents described, as these may vary. It is also to be understood that the terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs. Any methods and materials similar or equivalent to those described herein can be used in the practice or testing of the present invention.

All publications, including all patents, patent applications and other patent and non-patent publications cited or mentioned herein are incorporated herein by reference for at least the purposes that they are cited; including for example, for the disclosure or descriptions of methods of materials which may be used in the invention. Nothing herein is to be construed as an admission that a publication or other reference (including any reference cited in the “Background of the Invention” section alone) is prior art to the invention or that the invention is not entitled to antedate such disclosure, for example, by virtue of prior invention.

The skilled artisan will appreciate that the numerical values presented herein are approximate values. Generally, unless otherwise indicated, terms such as “about” and “approximately” include within 20% of the values indicated, more preferably within 10% and even more preferably within 5%.

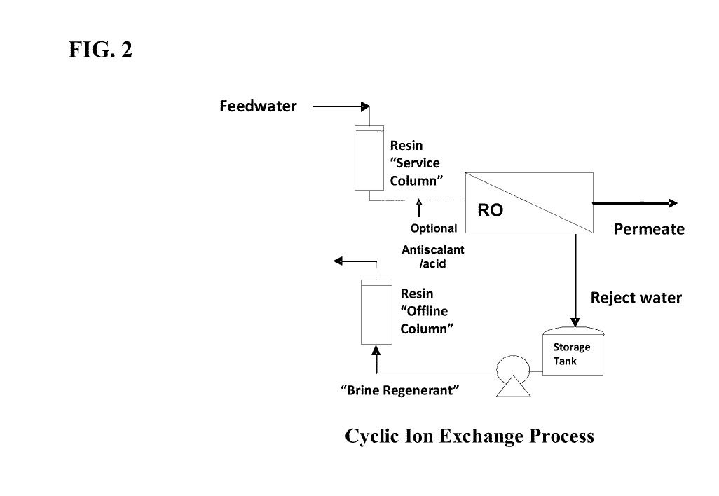

The invention provides a self-sustaining Cyclic Ion Exchange (or CIX-RO) method in which a strong acid cation resin is used to soften the feedwater to RO or NF plants with subsequent use of the reject brine stream from the membranes to regenerate the resin, with brine concentrations of the reject stream ranging as low as 0.1%, and without the need to supplement the brine composition with monovalent cation salts (FIG. 2).

In one embodiment, the invention provides a method of purifying water including:

a) passing feedwater through at least one service column having a cationic exchange resin capable of binding divalent cations that are present in the feedwater, wherein the loading of the divalent cations on the resin is restricted to about 1 to 25% of the available ion exchange sites on the resin, and the total cation concentration of the feedwater is greater than 100 mg/l;

b) feeding the water exiting the service column to a reverse osmosis membrane or a nanofiltration membrane to produce permeate water stream and a reject water stream wherein the reject stream contains a major fraction of the monovalent cations originally present in the effluent from the service column; and

c) passing the reject stream through at least one off-line column of strong acid cation resin capable of binding monovalent cations;

d) switching at least one service column to the offline mode and switching at least one offline column to the service mode and repeating steps (a) to (c) multiple times in order to achieve steady-state leakage of the divalent cations in the water exiting the service column, wherein the ratio of monovalent to divalent cations in the water exiting the service column is greater than 20 to 1.

Unless otherwise stated, the terms “service column” or “service vessels” or grammatical equivalents thereof, refer to any column or vessel capable of holding ion exchange resin(s) useful for softening water. The cyclic ion exchange system of the invention may comprise one or more service columns that are arranged, for example, in series or in parallel. In one embodiment of the invention, the service column comprises a resin that is predominantly in sodium form, that is, the resin contains bound Na⁺ cations. In another embodiment of the invention, the service column comprises a resin that is predominantly in sodium form but can bind Ca²⁺ and Mg²⁺ ions more strongly than Na⁺ cations.

The terms “off-line column” refers to any column or vessel capable of holding ion exchange resin. In one embodiment of the invention, the binding sites of the off-line column are predominantly bound with divalent cations. In another embodiment of the invention the binding sites of the off-line column are predominantly occupied by Ca²⁺ or Mg²⁺ ions, but the resin more strongly binds Na⁺ ions. In yet another embodiment of the invention, the off-line column is regenerated to a predominantly sodium form upon application of brine solution to the column. In another embodiment of the invention, the off-line column is regenerated to a predominantly sodium form upon application of a dilute brine solution across the column. In another embodiment of the invention the off-line column is regenerated and is substantially identical to the “service column” of the invention. In another embodiment of the invention, the regenerated “off-line column” is identical to a “service column” of the invention.

Those of ordinary skill in the art will readily appreciate that total cation concentration can be expressed in terms of the amount of CaCO₃ in solution. For example, the total cation concentration may be expressed as mg/l CaCO₃. In another embodiment of the invention, the total cation concentration can be expressed as meq/l. In yet another embodiment, the specified amount of CaCO₃ in solution can be used to calculate, e.g., the sum of calcium and magnesium ions in solution.

The term “cation exchange resin” refers to any matrix or support structure that is capable binding and releasing positive ions. For example, in one embodiment, the cation exchange resin is a porous organic polymer substrate with negatively charged functional groups on the stationary phase. In another embodiment, the cation exchange resin is a strong acid cation resin. In another embodiment, the cation exchange resin is a shallow shell cation resin with a functionalized shell and inert core.

The cationic exchange resin may comprise an insoluble matrix in the form of small beads. In this embodiment, the resin bead diameters range from about 100 to 2000 microns, or about 200 to 1500 microns, or about 250 to 1300 microns, where a bead diameter range of about 300 to 1200 microns is preferred, and specific bead diameters of about 300, 350, 400, 450, 500, 550, 600, 650, 700, 750. 800, 850, 900, 950, 1000, 1050, 1100, 1150, and 1200 microns are especially preferred. In another embodiment, the cationic exchange resin is a standard fine mesh cation resin with typical resin bead diameters ranging from about 200 to 400 microns, or about 200, 210, 220, 230, 240, 250, 260, 270, 280, 290, 300, 310, 320, 330, 340, 350, 360, 370, 380, 390, 400 microns, or any subset of the 200 to 1200 diameter range. Preferred bead diameter range is to use fine mesh for best efficiency, but to use standard beads with 300 to 1200 micron diameter or a subset for best hydraulics in terms of lower pressure drop across the resin bed compared to that for fine mesh resin. Examples of strong acid cation resins include Purolite C100, Dow Marathon C, and Rohm & Haas Amberjet 1200. Fine mesh resins include Purolite C100EFM and Dow C400. Shallow Shell Technology (SST™) resins include Purolite SST60, SST65 and SST80 resins.

In one embodiment of the invention, the term “divalent cation” refers to positively charged atoms, radicals or groups of atoms with a valence of +2, which travel to the cathode or negative pole during electrolysis. Examples of divalent cations may include, but are not limited to beryllium, magnesium, calcium, iron, manganese, radium, strontium, and barium cations. Preferred divalent cations are magnesium, calcium, iron, manganese, radium, strontium and barium.

In another embodiment of the invention, the term “monovalent cation” refers to ions having a single positive charge. Non-limiting examples of monovalent cations include hydrogen, lithium, sodium, potassium, ammonium, cesium and rubidium. Preferred monovalent cations are sodium and potassium. Sodium is especially preferred.

In another embodiment of the invention, the cation exchange resin is capable of binding divalent cations that are present in the feedwater. In another embodiment, the loading of the divalent cations on the resin is restricted to about 0 to about 25%, or about 1, 2, 3, 4, 5, 6, 7, 8, 9, 10, 11, 12, 13, 14, 15, 16, 17, 18, 19, 20, 21, 22, 23, 24, 25% of the available ion exchange sites on the resin. In another embodiment, the total dissolved solids in the feed water is in the range of about 10 to 10,000 mg/l, or about 20 to 500 mg/l, or about 30 to about 300 mg/l or about 40, 50, 60, 70, 80, 90, 100, 110, 120, 130, 140, 150, 160, 170, 180, 190, 200, 210, 220, 230, 240, 250, 260, 270, 280, 290 mg/l. In another embodiment, the total dissolved solids in the feedwater is greater than 100 mg/l.

In one embodiment of the invention, the water exiting the service column is softened water. In this embodiment, the chemical equivalent ratio of monovalent to divalent cations in the water exiting the service column is greater than about 5 to 1 or greater than 10 to 1 or greater than 20 to 1, or greater than 30, 40, 50, 60, 70, 80, 90, 100, 200, 300, 400, 500, 600, 700, 800, 900, 1000, 2000, 3000, 4000, 5000, 6000, 7000, 8,000, 9,000, 10,000, 20,000, 30,000, 40,000, 50,000, 60,000, or 70,000 to 1. In another embodiment of the invention, the chemical equivalent ratio of monovalent to divalent cations in the water exiting the service column is at least 100,000 to 1.

In another embodiment of the invention, the number of divalent ions in the feedwater is at least 50% or 55, 60, 65, 70, 75, 80, 85, 90, 91, 92, 93, 94, 95, 96, 97. 98, or 99% greater than the number of divalent cations in the reject stream. In a preferred embodiment of the invention, the number of divalent ions in the feedwater is at least 90% greater than the number of divalent cations in the reject stream.

In another embodiment of the invention, the water exiting the service column is applied to a RO or NF plant to produce a permeate water stream and a reject water stream (FIG. 2) In another embodiment, the reject water stream contains at least 10% of the total dissolved salts present in the water exiting the service column. In another embodiment of the invention, the reject water stream contains at least 15, 20, 25, 30, 35, 40, 45, 50, 55, 60, 65, 70, 75, 80, 85, 90, 91, 92, 93, 94, 95, 96, 97, 98, 99 or 100% of the total dissolved salts present in the water exiting the service column. In a preferred embodiment, the reject water stream contains at least 90% of the total dissolved salts present in the water exciting the service column. In another embodiment, the total dissolved salts of the reject stream from the membrane plant is equal to or greater than 0.01%. In another embodiment, the total dissolved salts from the membrane plant is equal to or greater than about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, or 1.0%.

In one embodiment of the invention, the reject stream is applied through at least one off-line column capable of binding monovalent cations. In another embodiment of the invention, the reject stream is used to regenerate the off-line column so that the column goes from being in predominantly bivalent cation form to predominantly monovalent cation form. In another embodiment of the invention, the entire reject stream is collected and used as a “regenerant brine” to regenerate at least one off-line column. In yet another embodiment of the invention, only part of the reject stream is collected and used as regenerate brine to regenerate at least one off-line column.

In another embodiment of the invention the reject stream is first collected and then subsequently applied to the off-line column after isolation from the RO or NF plant. In another embodiment, the reject stream is applied to the column in a simultaneous cyclic process where the reject stream is fed directly into the off-line column as it leaves the RO or NF plant.

In another embodiment, the rinse water used to displace the residual brine from the offline column and exiting at least one off-line column is disposed of. In another embodiment, the rinse water exiting at least one off-line column is collected and then subsequently applied to a service column. In yet another embodiment of the invention, the rinse water exiting at least one off-line column is applied to the inlet of a service column in a simultaneous cyclic process where the rinse water exiting the off-line column is fed directly into the service column as it leaves the off-line column.

In a preferred embodiment of the invention, the volume of reject stream produced by the RO or NF plant corresponding to a specific volume of water that has passed through the service column is used to regenerate one or more offline columns.

In another embodiment of the invention, the off-line column is regenerated using a counterflow mode of operation in which the influent feedwater and brine solutions are passed through the resin column in opposite directions.

In another embodiment of the invention, the offline column is rinsed with a volume of “rinse water” to displace the residual volume of regenerant brine that was applied to the off-line column from the reject stream. In another embodiment, “rinse water” comprises permeate water produced by the RO or NF plant. In another embodiment, the “rinse water” is water exiting the service column. In another embodiment, the rinse water exiting the off-line column is combined with the feedwater before it is passed to the service column. In yet another aspect of the invention, the rinse water exiting the off-line column is disposed of. In another aspect of the invention, the rinse water step is omitted when the total dissolved salts in the water exiting the service column is less than about 3000 mg/l.

In another aspect of the invention, the reject water from the RO or NF plant is collected in a tank and applied to the off-line column using a pump in fluid connection to the tank to control the flow rate of the regenerant brine in the off-line column. In another embodiment, the reject stream is applied to the off-line column at a rate equal to or faster than the rate at which it is produced by the RO or NF plant. In another embodiment, the reject stream is applied to the off-line column at a rate sufficient to maintain adequate velocity through the column to avoid, for example, flow imperfections such as channeling. In another embodiment, the reject brine is passed through the off-line column in the presence of intermediate pressure reduction. In another embodiment, the reject brine is passed through the off-line column without the presence of intermediate pressure reduction. In another embodiment, the pressure applied to feed the reject stream over the off-line column is facilitated by use of an ion exchange column with a metal thickness sufficient to withstand the normally high pressure at which the reject stream is discharged from the RO or NF plant.

In another embodiment, the flow rates of the volume of regenerant brine from the reject stream corresponding to a specific volume of water passing through the service column and the rinse water through the off-line column are adjusted so that the combined time period for applying the reject stream and rinse water to the off-line column is equal to or shorter than the time period needed for passage of the specific volume of feed water through the service column.

In another embodiment, the operation of the service column is “switched” so that it serves as an off-line column (in off-line mode) in the cyclic ion exchange process. In another embodiment, the operation of the off-line column is altered so that it serves as a service column in “on-line mode.”

In yet another embodiment, the above mentioned steps are repeated at least twice until divalent cation leakage achieves a steady state value. In another embodiment, the process is repeated until a desired steady-state harness leakage is achieved. In another embodiment, the steady-state hardness leakage is significantly lower than that obtainable from a conventionally designed and operated ion exchange softening system. In another embodiment, the steady-state leakage is controlled by modulating the volume of feed water softened per service so that only a limited and minor fraction of available ion exchange sites on the resin are utilized reversibly for loading and regeneration of divalent cations.

In one embodiment, the reject stream comprises ultra-low brine concentrations ranging from about 0.1% and greater, previously considered to be inefficient and costly for regenerating resins. In another embodiment of the invention, the reject stream is used to effectively regenerate the resin without having to supplement with extra salt. In another aspect of the invention, the reject stream regeneration step achieves hardness leakage of less than about 0.01 to 0.1, 0.1 to 1, 1 to 100 ppm or less than about 0.01, 0.1, 1, 2, 3, 4, 5, 6, 7, 8, 9, 10, 15, 20, 25, 30, 35, 40, 45, 50, 55, 60, 65, 70, 75, 80, 85, 90, 95, 100 ppm.

In another embodiment of the invention, no supplemental salt need be added for regeneration of the off-line resin. In another embodiment of the invention, additional salt in the range of greater than 0% to about 10% sodium chloride is added to regenerate the resin, wherein concentration ranges of greater than about 0 to 5% or about 0.05, 0.1, 0.2, 0.3, 0.4, 0.5, 0.6, 0.7, 0.8, 0.9, 1, 1.5, 2, 2.5, 3, 3.5, 4, 4.5, and 5% are preferred.

In another embodiment, a set of ion exchange water softeners (“service columns”) are used to soften a specific volume of the feedwater before the water is used by the membrane plant. In yet another embodiment, the design times and flow rates for all regeneration steps, including brining, rinsing and resin bed settling, is adjusted so that the steps are completed in time to enable smooth switching of the “offline columns” into softening service mode while the other set of softeners are put into the offline/regeneration mode, without interruption of the flow of feedwater to the membrane plant (FIG. 2).

Without being bound by any theory or mechanism of the invention, it is believed that an integral part of the success of the invention is a radical shift in the design and operating philosophy compared to that used for conventional water softeners used in the past for pre-softening feedwater for RO plants. For example, conventional ion exchange softening processes use commercial sodium chloride salt at a 10% concentration for resin regeneration. Conventional softeners typically comprise salts that can contain about 2500 mg of hardness per kilogram of salt, which equates to a sodium to hardness ratio in the 10% brine of 400 to 1. The CIX-RO softening process of the present invention, on the other hand, relies on the comparatively dilute concentration of monovalent cations (e.g. 0.1 to 1%) in the reject stream from the downstream RO or NF plant for regeneration of the resin. A brine solution with very low hardness content is critical for successfully regenerating the CIX-RO softener. At the low brine concentrations used for the CIX-RO process, it is necessary for the monovalent to divalent cation ratio to be many times higher than the same ratio for commercial brine since the driving force is much lower for exchanging hardness cations for monovalent cations during the regeneration process.

Conventional ion exchange water softeners are designed by first determining the maximum and average hardness leakage (i.e. divalent cations such as calcium and magnesium) that can be tolerated in the softened water based on the specific application in which it is used (e.g. 1 to 2 ppm average hardness is typical for feed water used in low pressure boilers). Once the target hardness leakage is known, the minimum dosage of the regenerant sodium chloride salt needed to achieve the target leakage is selected using standard engineering bulletins or software for water softening resins available from a number of manufacturers (e.g. for Purolite C100 strong acid cation resins available at www.purolite.com). The salt dosage is the quantity of salt applied per liter of resin during the regeneration process. Once the salt dosage is determined, a calculation is done to determine the maximum volume of water that can be softened before the maximum target hardness value is exceeded.

Thus, for conventional ion exchange softeners, the operating philosophy is to maximize the volume of water softened per cycle until the desired hardness breakpoint is achieved. Then the resin is regenerated with a brine solution (preferably 10%) as this provides efficient elution of the hardness from the resin while minimizing the volume of water used to prepare the brine solution. In conventional systems, maximizing the volume of water treated also minimizes the frequency of regeneration and thus minimizes the volume of waste water generated from backwashing and rinsing of residual brine from the resin before reuse. Under this philosophy, typical hardness loading of the resin is generally 40% to 70% of the theoretical maximum capacity of the resin, with 55% to 70% being typical. For example, for a typical strong acid cation resin with a total capacity of 2 equivalents of exchange capacity per liter of resin, 40% to 70% of capacity, or about 0.8 to 1.4 equivalents of exchange capacity per liter of resin is used. In another example, the desired hardness leakage can be achieved by treating raw water containing a hardness content of 200 mg/l as CaCO₃ with a salt dosage of 96 grams/liter. Typical resin capacity is about 1.1 equivalent of hardness loaded per liter of resin or about 275 bed volumes of water treated (where 1 bed volume is equal to 1 liter of treated water per liter of resin).

Thus conventional water softeners are designed by selecting a salt dosage which will achieve a specified average hardness leakage after a calculated volume of water has been treated. Such a water softener is subsequently put into service and hardness leakage in the treated water is allowed to climb to a selected maximum hardness level or “breakpoint” concentration before the softener is taken out of service and regenerated with a brine solution.

The hardness leakage estimates in design engineering bulletins make allowance for a significant level of hardness impurity in the commercial salt that is used for regeneration, a typical hardness content of the salt being about 2500 mg hardness per kg of dry salt. The conventional practice of calculating and operating the softener to a breakpoint hardness concentration in the treated water is not suitable for a softener designed and operated according to the Cyclic Ion Exchange (CIX-RO) process of the present invention in which ultra-low brine concentrations are used for regeneration.

The affinity of the resin for divalent cations such as calcium over monovalent cations such as sodium is given by the following formula:

[Ca]ᵣ/[Na]ᵣ=α^{Ca}_{Na}×[Ca]ₛ/[Na]ₛ
where:
[Ca]ᵣ is the concentration of calcium on the resin in meq/l;
[Na]ᵣ is the concentration of sodium on the resin in meq/l;
α^{Ca}_{Na} is the separation factor for calcium versus sodium;
[Ca]ₛ is the concentration of calcium in the solution in meq/l;
[Na]ₛ is the concentration of sodium in the solution in meq/l;

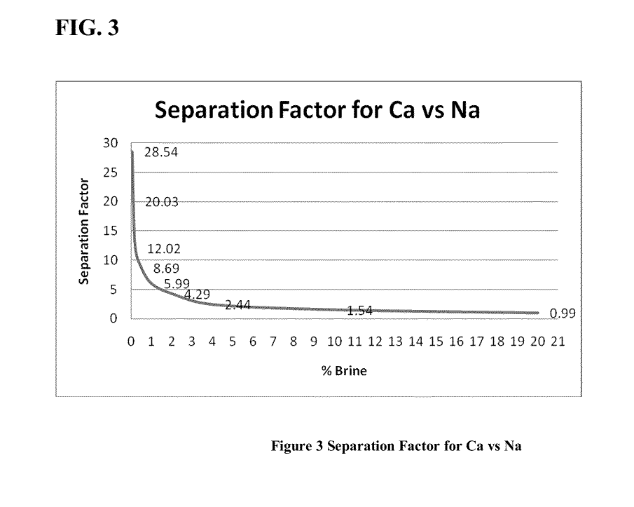

This preference for the divalent calcium cation over the monovalent sodium cation at low brine concentrations is also depicted in FIG. 3. At typical raw water TDS of 0.05% (or 500 mg/l) the affinity for calcium over sodium is very strong with a separation factor greater than 28. However, this affinity for calcium changes dramatically when working with a concentrated 10% brine solution. At 10% brine concentration the separation factor for calcium over sodium is only 1.54, or about 18 times lower. In other words, at a 10% brine concentration, the resin exhibits a much lower preference for calcium and regeneration of the resin or elution of the hardness from the resin becomes a much easier task. Hence the industry has adopted 10% brine concentration as the standard for regenerating water softeners.

For the CIX-RO process it is important to control and minimize the hardness content of the brine used to regenerate the CIX-RO resin. Thus, the initial and on-going hardness leakage of the softened water achieved throughout the service cycle must be maintained as low as possible since it will be subsequently concentrated on passage through the RO and be used via the RO reject stream to regenerate the resin. Utilizing brines with high sodium to calcium ratio results in efficient regeneration of the cation softener resin where a large fraction of the ion exchange sites on the resin are left in the regenerated sodium form.

For example, commercial salt typically has a hardness content greater than 2500 mg/kg in the dry salt, corresponding to a sodium to hardness equivalent ratio of about 400 to 1. When a 10% brine concentration is used, the separation factor or affinity of the resin for calcium over sodium is 1.54 (FIG. 3). Using the above separation formula, the 99.62% of the ion exchange sites can be converted to the sodium form and calcium hardness occupies 0.38% of the ion exchange sites, providing an equivalent sodium to hardness ratio on the resin of 259.74 to 1. If this resin is then used to soften a raw water with a TDS of 1000 mg/l, the separation factor for calcium to sodium is 20 to 1, and the minimum hardness leakage into the treated water is calculated to be 0.2 mg/l as CaCO₃.

When the same analysis is done using an ultra-low brine concentration of 0.5% to soften raw water with a TDS of 1000 mg/l, the separation factors are 8.7 and 20 for the regeneration and service phases respectively. In order to achieve a hardness ratio of 259.74 to 1 during regeneration the hardness content of the brine would have to be a maximum of 2.2 mg/l. This amounts to a sodium to hardness equivalent ratio in the brine of 2260 to 1, which is about 5.6 times higher than the ratio needed when using 10% brine of 400 to 1.

The above analysis demonstrates that when regenerating resins using ultra low brine concentrations (e.g. 0.1% brine or higher) maintaining a very high equivalent ratio of sodium to hardness is highly desirable and very critical to achieving a low hardness leakage in the treated water. Thus preferred monovalent cation to divalent cation ratios in the fresh brine are greater than 5,000 to 1, and more preferably greater than 10,000 to 1.

Therefore, in one embodiment of the invention, the CIX-RO process design is geared to maintain production of high purity brines via the reject brine from the RO or NF plant by deliberately controlling the volume of water treated per cycle to a minimum practical amount so that the hardness content of the softened water is extremely low. For example, in one embodiment, the feedwater applied to the top of the column exits from the bottom, so that the loading of hardness cations is largely confined to the resin at the top portion of the column, leaving the resin at the bottom of the column in a highly regenerated state and with a very high sodium to hardness ratio.

In another embodiment, restricting the hardness cations on the top of the column (i.e., loaded away from the bottom of the column), the sodium to hardness ratio at the bottom of the column remains close to the original value established during the previous regeneration cycle. Thus the sodium to hardness ratio in the softened water and in the reject brine from the RO or NF plant is high enough to achieve the degree of conversion of the resin to the sodium form on subsequent regeneration. This cyclical phenomenon of minimizing the hardness leakage from the column in turn impacts the regeneration efficiency during subsequent cycles and continues until stable steady state equilibrium is reached.

As generally known in the art, greater than 99% of the total dissolved solids (TDS) of the influent water can be rejected by conventional RO membranes. For example, in a membrane plant operating at 90% permeate recovery, 10% of the water is rejected containing essentially all of the dissolved solids present in the influent water except for a small amount (typically less than 0.5% for RO membranes) that passes through the membranes as part of the permeate. The TDS of the reject brine at 90% permeate recovery is approximately 10 times that of the influent water, with a sodium to hardness ratio almost the same as that in the softened feedwater, except for some preferential rejection of the divalent cations. Thus for a feedwater with a TDS of 1000 mg/l, the brine TDS will be slightly less than 10,000 mg/l or 1% brine.

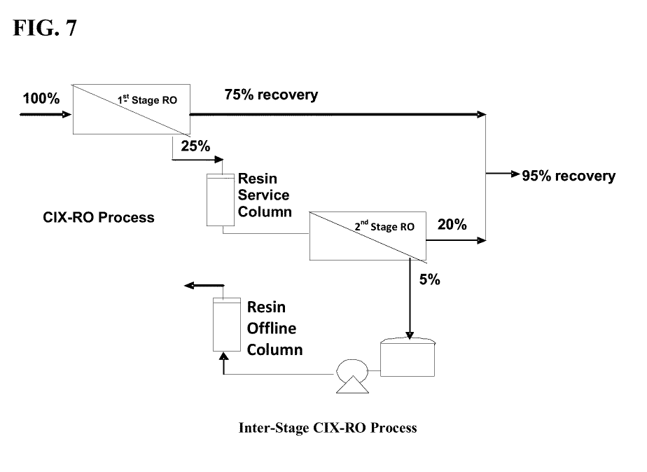

In one embodiment of the invention, the cyclic ion exchange process is an “inter-stage” softening process designed for use with multi-stage RO or NF plants in which the reject water from the first stage of the membrane plant is softened by the CIX-RO “service column” and the softened water is then fed to the second stage of the plant, wherein the reject water from the second stage is used to regenerate the “offline column” (FIG. 7). In another embodiment, the inter-stage softening is applicable for cases in which the solubility of scale forming compounds is not exceeded by the extent of concentration that occurs in the reject water on passage through the first RO or NF stage, but the solubility can be exceeded by the extent of concentration expected across the membranes of the second stage of the RO or NF plant.

One embodiment the invention provides feedwater to RO and NF plants to be efficiently softened to very low single digit levels of hardness or less without the need to purchase commercial salt for this purpose. The reduction in cost for regeneration salt and for labor results in significant savings compared to systems using conventional water softeners. The process is environmentally friendly as no extra salt needs to be purchased or discharged via spent brine to the environment. The low hardness leakage achieved by the inventive method allows RO and NF plants to be operated at higher permeate recovery rates since hardness can be concentrated to a higher extent in the RO or NF reject stream before the solubility limits for the hardness compounds are exceeded. Increased recovery rate results in low feed water volume requirements and thus volume of feed water, to dispose of a correspondingly lower volume of reject water and a lower cost for pumping the water.

When ion exchange softening of the feedwater is combined with reduced dosage of antiscalant chemical, the potential exists to achieve a higher rate of water recovery than possible with either application of the invention or antiscalant dosing alone.

The following examples serve to more fully describe the manner of using the above-described invention, as well as to set forth the best modes contemplated for carrying out various aspects of the invention. It is understood that these examples in no way serve to limit the true scope of the invention, but rather are presented for illustrative purposes.

### EXAMPLES

### Example 1

### Optimizing Resin Bed Utilization

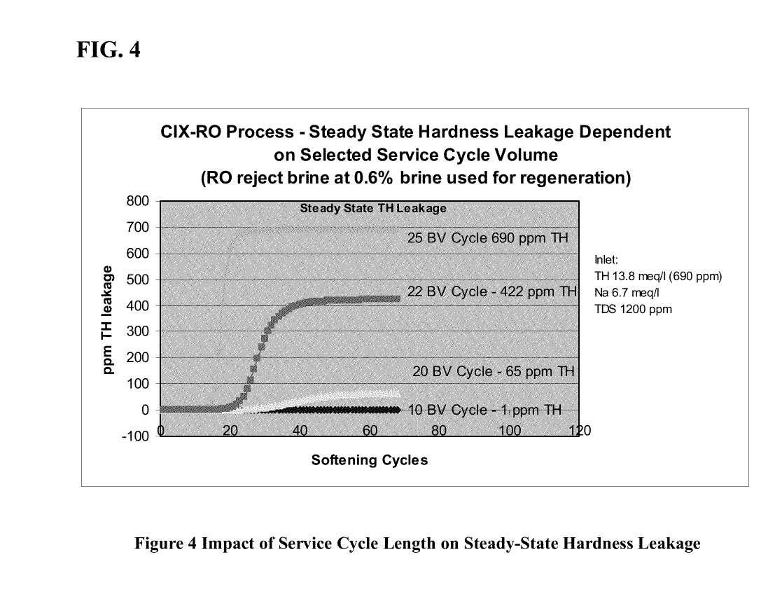

In Example 1, the importance of minimizing resin bed utilization is demonstrated. Water with 690 mg/l total hardness and a sodium content of 154 mg/l and total dissolved solids (TDS) of 1200 mg/l is softened using the CIX-RO process with a RO plant operating at 80% recovery and with a reject brine of approximately 0.6% (6000 mg/l TDS). A series of simulations are performed, pre-selecting a specific volume of water to be softened and then initiating regeneration with the corresponding volume of reject brine generated by the RO. Multiple softening/regeneration cycles are done until hardness leakage in the softened water reached steady state equilibrium. Results are shown in FIG. 4 for service bed volumes of 10, 20, 22 and 25. For every 10 bed volumes service volume softened, 2 bed volumes of RO reject are used to regenerate the resin before commencing the next cycle. Steady state hardness leakage of 1 ppm total hardness can be achieved when softening 10 bed volumes of feedwater per cycle. At 20 bed volumes per service cycle, hardness climbs rapidly to a steady state value of 65 ppm after 60 softening cycles. At 22 bed volumes per softening cycle, steady state hardness leakage again climbs rapidly to 422 ppm. At 25 bed volumes per softening cycle hardness leakage climbs to the influent value of 690 ppm after about 25 softening cycles.

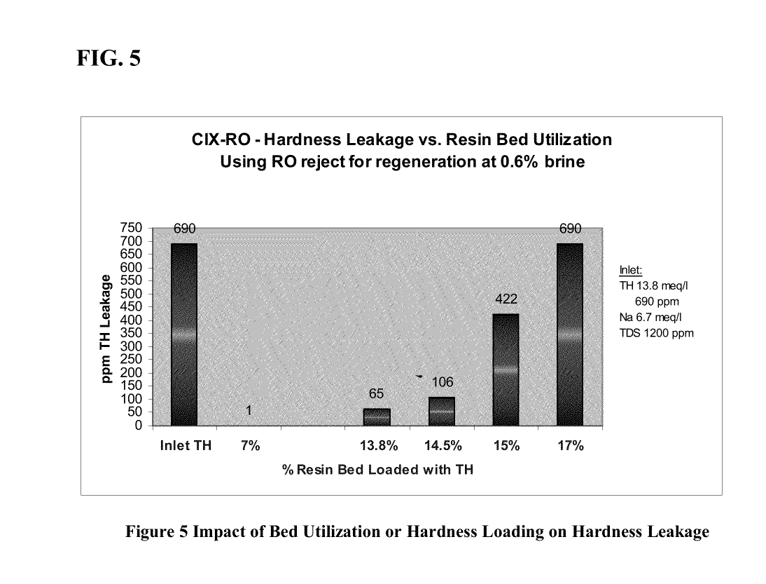

The percentage of sites loaded with hardness in the above experiments was plotted for each of the selected cycle lengths in FIG. 5. As shown in FIG. 5, the shortest cycle length utilizing the lowest fraction of available exchange sites gives the best control over leakage. At the 10 bed volume service cycle, only 7% of the resin bed is utilized reversibly for hardness loading, and the resulting hardness leakage is 1 ppm. At 20 BVs service cycle, the working area of the resin bed corresponds to about 14% of the resin sites with steady state hardness leakage at 65 ppm.

For comparison, PureDesign calculation software available from Purolite (www.purolite.com) was used to determine the loading rate when commercial salt is used for regeneration of the resin at 10% brine. A dosage of 80 g/l NaCl was used to correspond with the ratio of sodium to hardness in the feedwater. Results are as follows:

### PureDesign Output:

80 g/l 10% NaCl

1.21 eq NaCl to 1 eq TH

1.5 ppm TH leakage

82 BV per softening cycle

Resin sites reversibly utilized: 57%

Bed utilization for the conventional softener design as per PureDesign is 57% compared to the 7% bed utilization needed to achieve the similar hardness leakage when using the CIX-RO process with 0.6% reject brine.

### Example 2

### Modulating Harness Leakage from Ion Exchange Column

The ability to modulate hardness leakage by closely controlling the volume of water softened per cycle with the CIX-RO process is examined in Example 2.

Softening of a tertiary wastewater and regenerating with the reject from an 80% recovery RO is simulated by running multiple softening cycles, choosing 40 and 100 bed volumes of water to be softened per service/regeneration cycle and using 8 and 20 bed volumes of RO reject respectively per regeneration in counterflow mode. The wastewater composition includes 250 mg/l total hardness, 345 mg/l sodium and a TDS of 1200 mg/l.

PureDesign software is used to calculate the capacity and hardness leakage in counterflow mode for uniform particle size strong acid cation resin using commercial salt. Salt dosage is 175 g/l to match the sodium to hardness ratio in the feedwater. Hardness leakage is computed at 0.82 mg/l and capacity is evaluated at 266 bed volumes, effectively utilizing 1.33 equivalent of capacity per liter of resin or 66% of available capacity.

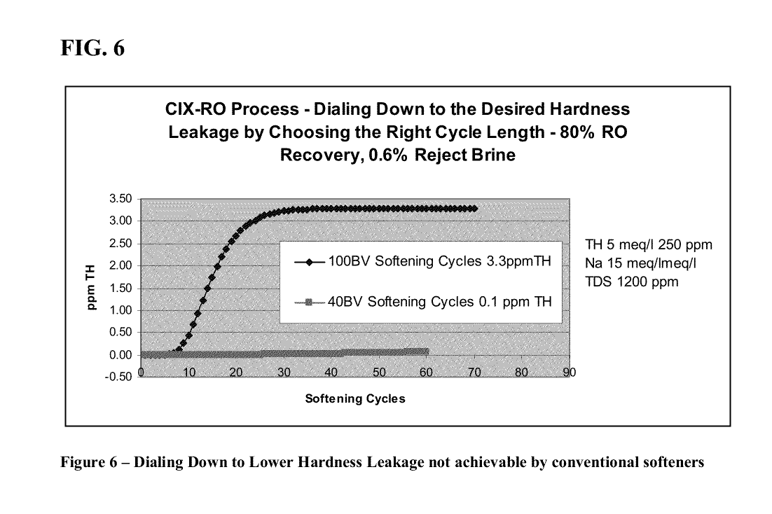

As illustrated in FIG. 6., choosing a service cycle length of 100 bed volumes results in steady state leakage of 3.2 mg/l after 60 softening cycles. Choosing a service cycle length of 40 bed volumes results in an extremely low steady-state hardness leakage of 0.1 mg/l after 60 softening cycles, lower than that obtained for the design of a conventional water softener.

This demonstrates a major advantage of the CIX-RO invention compared to conventional softener design with the ability to dial down to steady state hardness leakages that are significantly lower. The benefits include reduced scaling potential on downstream membranes and high system efficiency.

### Example 3

### Regenerating CIX-RO Resin with 0.5% RO Reject Brine

In Example 3, a cyclic ion exchange softening process was carried out to soften the feedwater to a RO plant operating at a high permeate recovery rate of 90% while treating a brackish water similar to that of Colorado River. The components of the feed water are shown in Table 1.

TABLE 1
Surrogate Colorado River Water

| Salt | meq/l | mg/l | |
|---|---|---|---|
| Calcium | 4.23 | 85 | |
| Magnesium | 2.55 | 31 | |
| Total Hardness | 6.78 | 339 | mg/l as CaCO₃^{#} |
| Sodium | 5.39 | 124 | |
| Barium | 0.00204 | 0.14 | |
| Sulfate | 4.99 | 240 | |
| Bicarbonate | 2.95 | 180 | |
| Chloride | 4.23 | 150 | |
| Silica | 0.16 | 10 | |
| TDS | 12.33 | 616 | mg/l as CaCO₃ |

^{#}total hardness was taken as the sum of calcium and magnesium in the water.

1200 gallon batches of the above test solution were used to supply a matched pair of two counter flow operated water softening columns, each of 1 inch diameter×60 inches height, and each containing 3 liters of Purolite SST65 shallow shell strong cation exchange resin. The resin in both columns was fully regenerated to the sodium form using a 10% brine solution at a dosage of 160 g/l before the test was started. Apart from this initial salt used to regenerate the resin, no additional salt was used throughout the test, relying solely on the salt content of the water for regeneration of the resin. One resin column was used (on-line) in softening service to supply treated water at a flow rate of 1.2 liter per minute (24 BV/h) to a small single stage RO with a Filmtec XLE4021 membrane element for a total of 75 minutes duration or 30 bed volumes of water based on the volume of resin in the column. The loading of hardness was deliberately restricted to 30 bed volumes capacity to limit the working capacity of the resin column to about 10% of the theoretical capacity. The design was to regenerate the resin column in counter flow mode so as to ensure that the larger resin fraction near the effluent end of resin column remained in a highly regenerated sodium state to facilitate production of softened water with very low hardness leakage. The RO was operated at approximately 90% recovery, facilitated by recirculating at least 8 liters per minute of RO reject brine concentrate back to the feed end to provide minimum concentrate flow to the membrane as recommended by the manufacturer. The net volume of rejected brine amounting to 10% of the total volume of feedwater was collected in a tank and used to regenerate the off-line resin column in a counter flow mode; the column was then rinsed with 1 bed volume of permeate. The two resin columns were then switched, the regenerated column proceeded on-line while the service column was switched to regeneration mode. A PLC control system was used to control the service, brining, rinse and synchronized switching of the resin columns, allowing continuous operation of the RO system without flow interruption. Each resin column was put through 95 softening and regeneration cycles over a 10 day period to verify that the softening process had reached steady state in terms of control over hardness leakage from the column. An antiscalant, Genesys LF from Genesys International, was dosed at 2 mg/l downstream of the water softeners throughout the pilot test to verify that the antiscalant would have no impact on the regeneration efficiency of the resin columns and to also protect the membrane against potential fouling by silica at the high recovery rate used.

Chemical parameters of the test solution, softened, permeate and RO reject were analyzed throughout the test on a daily basis along with recording of flow rate, pressure and temperature.

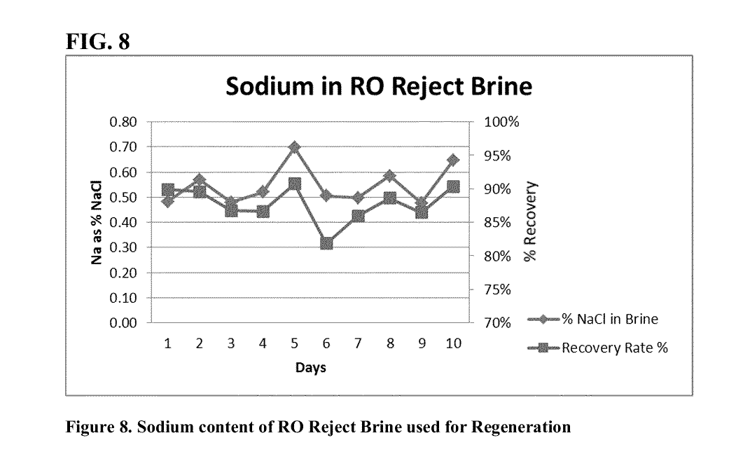

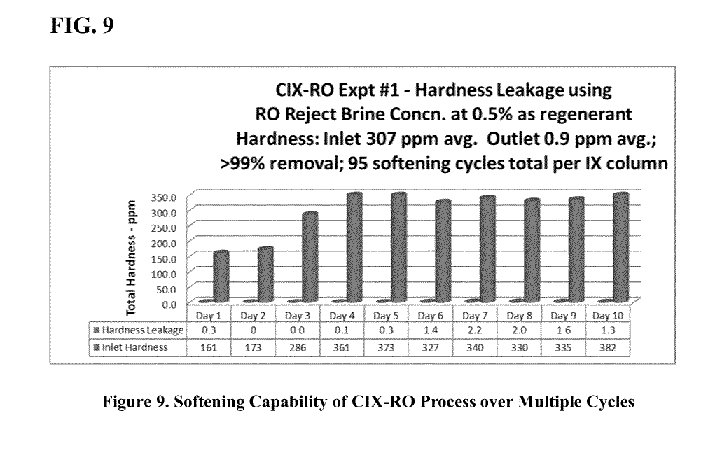

FIG. 8 shows the concentration of sodium analyzed in the RO reject brine expressed as percent sodium chloride based on samples taken daily over the period of the pilot test. The RO recovery rate based on the ratio of permeate to feed water flowrates is also shown in FIG. 8 for comparison. Average RO recovery rate ranged generally from 86% to 90%, with one excursion to 80% due to a mechanical issue. Sodium concentrations expressed as percent NaCl in the RO reject brine ranged from 0.48% to 0.70% with an average of 0.55%. Throughout the test, greater than 99.7% of the total hardness was removed by the ion exchange resin, with hardness leakage from the softeners averaging at 0.9 mg/l versus a value of 339 mg/l hardness in the raw synthetic water used for the test as shown in FIG. 9.

Each ion exchange column was subjected to 95 softening and regeneration cycles over the period of the test, and calculation showed that during this period a total of 17.1 equivalents of total hardness were removed from the water by each liter of resin, verifying that the softening process had achieved overall operating stability, with efficient elution of the hardness during each regeneration cycle. It is important to note that this removal efficiency was obtained without the use of any supplemental salt for regeneration. It should be noted that the average hardness concentration of 0.9 mg/l obtained in this experiment was an order of magnitude lower than the hardness leakage of 9 mg/l obtained by Bresler while treating a raw water with a similar influent hardness level of with 400 mg/l. This is even more remarkable since the brine concentration used in this experiment was an average of 0.5% compared to the calculated value from the Bresler experiment of 1.23%. The higher brine concentration used by Bresler would provide 1.6 times higher driving force for regeneration of the resin based on difference in selectivity. The monovalent to divalent cation ratio of the softened water in this experiment was calculated at an average of 685 to 1 representing about 4.4 times higher and better than that the ratio obtained by Bresler of 155 to 1.

The influent test water exhibited a low ratio of monovalent to divalent cations (in meq/l) of 0.79 to 1 (i.e. 5.39 meq/l/6.78 meq/l). Since no supplemental salt was used for the test, one would predict that there would be insufficient monovalent cations in the water to be used as a regenerant. However, the RO reject brine was used quite successfully to regenerate the resins repeatedly to steady state operating condition without adding extra salt. In particular, it was observed that during the softening process, divalent cations were collected by the resin while an equivalent amount of sodium was released into the treated effluent. This essentially increased the monovalent concentration to approximately 12.2 meq/l (i.e. 5.39+6.78). On passage through the RO, a minor fraction of approximately of 8% or about 0.98 meq/l was lost through the permeate water; the balance of 11.2 meq/l was left to concentrate in the RO reject brine and was subsequently used to regenerate the resin. Thus, once the resin achieved steady state operation, every cycle 11.2 meq of sodium was used to elute off 6.78 meq of hardness from the resin. This amounted to a ratio of 1.65 meq of monovalent to 1 meq of divalent cations; the excess monovalent cations provided more than enough chemical driving force to successfully elute the hardness loaded on the resin from the previous service cycle. At steady-state operation, every regeneration reloads enough monovalent cations from the RO reject brine back on to the resin in preparation for softening the volume of raw water in the next cycle.

Importantly, it was discovered that the ability to regenerate the resin is directly related to the net amount of monovalent cations present in the RO rejected brine, and allowance must be made in sustainable capacity estimates for any losses via the RO permeate. Losses are dependent on the specific RO plant design, the rejection rate of the specific membranes chosen and whether any recycle of reject brine is performed.

### Example 4

### Regenerating CIX-RO Resin with 0.2% RO Reject Brine

In Example 4, a cyclic ion exchange softening procedure was carried out to soften the feedwater to a RO plant using an ultra-low reject brine concentration of 0.2%. The components of the synthetic semi-brackish feed water used in this experiment are shown in Table 2.

TABLE 2
Semi-brackish Water

| Salt | meq/l | mg/l | |
|---|---|---|---|
| Calcium | 2 | 40 | |
| Magnesium | 2 | 24.4 | |
| Total Hardness | 4 | 200 | mg/l as CaCO₃ |
| Sodium | 5 | 115 | |
| Barium | 0.003 | 0.03 | |
| Sulfate | 2 | 96 | |
| Bicarbonate | 5 | 305 | |
| Chloride | 2 | 71 | |
| TDS | 9 | 450 | mg/l as CaCO₃ |

^{#}total hardness was taken as the sum of calcium and magnesium in the water.

The same CIX-RO pilot used in Example 3 was used for Example 4, with the resin columns being regenerated initially with 160 g NaCl per liter of resin at a 10% brine concentration. Apart from this initial salt used to regenerate the resin, no additional salt was used throughout the test, relying solely on the salt content of the water for regeneration of the resin. One resin column was used (on-line) in softening service to supply treated water at a flow rate of 1.0 liter per minute (20 BV/h) to the single stage RO for a total of 86 minutes duration or 28.6 bed volumes of water based on the volume of resin in the column. The RO was operated at approximately 80% recovery with a concentrate recirculation of approximately 8 liters per minute. The net volume of rejected brine was collected in a tank and used to regenerate the off-line resin column in a counter flow mode; the column was then rinsed with 1.33 bed volumes of permeate. The two resin columns were then switched, the regenerated column was positioned on-line while the service column was switched to regeneration mode. The PLC control system was used to control the service, brining, rinse steps with synchronized switching of the resin columns, allowing continuous operation of the RO system without flow interruption. Each resin column was put through 85 softening and regeneration cycles over a 10 day period to verify that the softening process had reached steady state in terms of control over hardness leakage from the column. An antiscalant, Genesys LF from Genesys International, was dosed at 2 mg/l downstream of the water softeners throughout the pilot test to verify that the antiscalant would have no impact on the regeneration efficiency of the resin columns.

Chemical parameters of the test solution, permeate and RO reject were analyzed throughout the test, along with recording the flow rate, pressure and temperature.

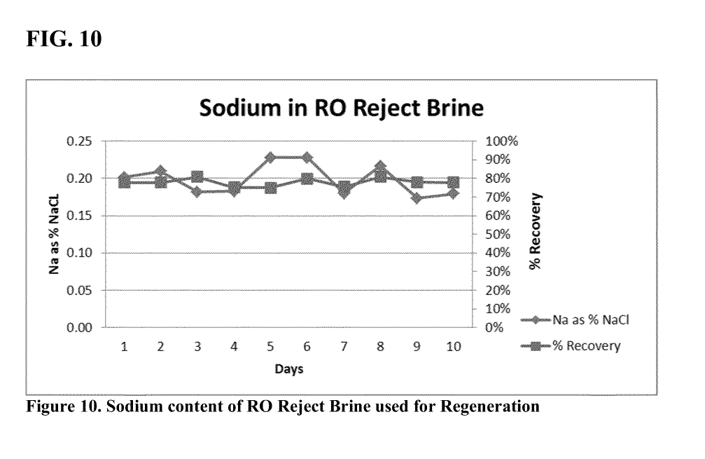

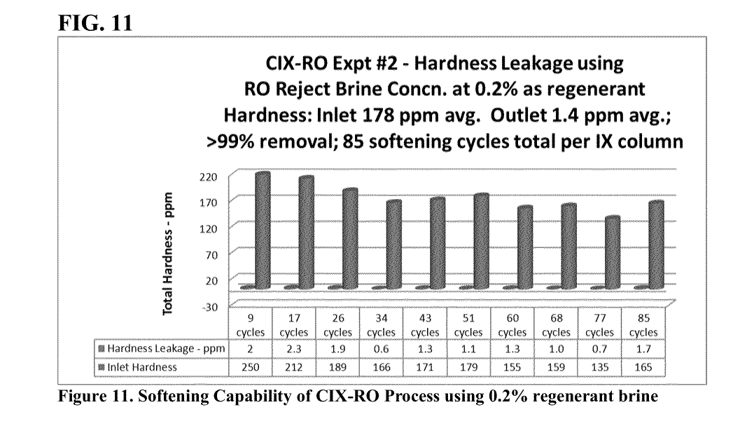

FIG. 10 shows the concentration of sodium analyzed in the RO reject brine expressed as percent sodium chloride for samples taken daily over the period of the pilot test. The RO recovery rate based on the ratio of permeate to feed water flow rates is also shown in FIG. 10. RO recovery rates ranged generally from 75% to 81% with an average of 78%. Sodium concentrations expressed as percent NaCl in the RO reject brine ranged from 0.17% to 0.23% with an average of 0.20%. Throughout the test, greater than 99.3% of the total hardness was removed by the ion exchange resin, with hardness leakage from the softeners averaging at 1.4 mg/l versus an average value of 178 mg/l hardness in the raw synthetic water used for the test (FIG. 11).

Each ion exchange column was subjected to 85 softening and regeneration cycles over the period of the test. Calculation showed that during this period a total of 8.7 equivalents of total hardness were removed from the water by each liter of resin, verifying that the softening process had achieved overall operating stability and efficient elution of the hardness was occurring during each regeneration cycle.

### Example 5

### Regenerating CIX-RO Resin with 0.1% RO reject brine

In Example 5, a cyclic ion exchange softening process was carried out to soften the feedwater to a RO plant operating using an ultra-low reject brine concentration of 0.1%. The components of the synthetic semi-brackish feed water used in this experiment is shown in Table 3.

TABLE 3
Semi-brackish Water

| Salt | meq/l | mg/l | |
|---|---|---|---|
| Calcium | 1 | 20 | |
| Magnesium | 1 | 12.2 | |
| Total Hardness | 2 | 100 | mg/l as CaCO₃^{#} |
| Sodium | 2.5 | 57.5 | |
| Sulfate | 1 | 48 | |
| Bicarbonate | 2.5 | 152.5 | |
| Chloride | 2 | 71 | |
| TDS | 5 | 225 | mg/l as CaCO₃ |

^{#}total hardness was taken as the sum of calcium and magnesium in the water.

The same CIX-RO pilot used in Example 3 was used for Example 5, following the same operating procedure as in Example 4, regenerating initially with 10% brine, and then using only the reject brine from the RO for all subsequent regenerations.

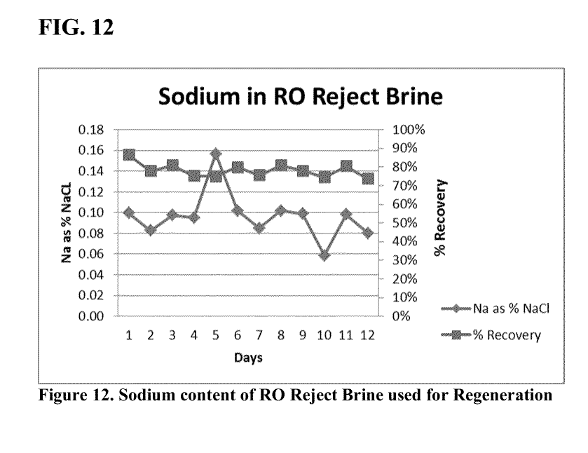

FIG. 12 shows the concentration of sodium analyzed in the RO reject brine expressed as percent sodium chloride based on grab samples taken daily over the period of the pilot test. The RO recovery rate based on the ratio of permeate to feed water flow rates is also shown in FIG. 12 for comparison. RO recovery rates averaged 78%. Average sodium concentrations expressed as percent NaCl in the RO reject brine was 0.1%. Throughout the test, greater than 97% of the total hardness was removed by the ion exchange resin, with hardness leakage from the softeners averaging at 2.8 mg/l versus an average value of 97 mg/l hardness in the raw synthetic water used for the test (FIG. 11).

Each ion exchange column was subjected to 100 softening and regeneration cycles over the period of the test. Calculation showed that during this period a total of 5.4 equivalents of total hardness were removed from the water by each liter of resin, verifying that the softening process had achieved overall operating stability and efficient elution of the hardness was occurring during each regeneration cycle.

1. A method of purifying water comprising:
a) passing a specific volume of feedwater through at least one service column comprising a cationic exchange resin capable of binding divalent cations that are present in the feedwater, wherein the loading of the divalent cations on the resin is restricted to about 1 to 50% of the available ion exchange sites on the resin, and the total cation concentration of the feedwater is greater than 100 mg/l;
b) feeding the water exiting the service column to a reverse osmosis membrane or a nanofiltration membrane to produce a permeate water stream and a reject water stream; and
c) passing the reject stream through at least one off-line column comprising a cationic exchange resin capable of binding monovalent cations,
wherein the number of divalent ions in the feedwater is at least 90% greater than the number of divalent cations in the reject stream.

2. The method according to claim 1, wherein the ratio of the number of monovalent ions to divalent ions in the reject stream is greater than 20 to 1.

3. The method according to claim 1, wherein the loading of the divalent cations on the resin is restricted to 1 to 20% of the available ion exchange sites on the resin.

4. The method according to claim 1, wherein the loading of the divalent cations on the resin is restricted to 1 to 15% of the available ion exchange sites on the resin.

5. The method according to claim 1 wherein the service column comprises a resin that is predominantly in sodium form.

6. The method according to claim 1, wherein the reject water stream comprises at least about 90% of the total dissolved salts present in water exiting the service column.

7. The method according to claim 1, wherein the reject water stream comprises at least about 95% of the total dissolved salts present in the water exiting the service column.

8. The method according to claim 1, wherein the total dissolved salts in the reject stream are at least about 0.1%.

9. The method according to claim 1, wherein the water exiting the off-line column is fed directly into the service column as it leaves the off-line column.

10. The method according to claim 1, wherein the reject stream is fed directly into the off-line column as it leaves the reverse osmosis or nanofiltration membrane.

11. The method according to claim 1, wherein the chemical equivalent ratio of monovalent to divalent cations in the water exiting the service column is greater than 1000 to 1.

12. The method according to claim 1, wherein the total cation concentration is based on an amount of CaCO₃ present in the solution.

13. A self-sustaining method of purifying water comprising:
a) passing a specific volume of feedwater through at least one service column comprising a strong acid cationic exchange resin capable of binding divalent cations that are present in the feedwater, wherein the loading of the divalent cations on the resin is restricted to about 1 to 25% of the available ion exchange sites on the resin, and the total cation concentration of the feedwater is greater than 100 mg/1;
b) feeding the water exiting the service column to a reverse osmosis membrane or a nanofiltration membrane to produce a permeate water stream and a reject water stream with the reject stream containing a major fraction of the monovalent cation content of the water exiting the service column;
c) passing all or some of the volume of the reject stream corresponding to the specific volume of feedwater through at least one off-line column comprising a cationic exchange resin capable of binding monovalent cations;
(d) passing a volume of rinse water through the off-line column, the rinse water selected from the group consisting of purified water from the effluent of the service column, permeate water produced by a membrane plant, or water from an external source substantially free of divalent cation content;
(e) adjusting and synchronizing the flow rates of the volume of the reject stream used in (c) and the volume of rinse used in (d) so that the combined time period for applying the reject stream and rinse water to the off-line column is equal to or shorter than the time period needed for passage of the specific volume of feed water in (a) through the service column; and
f) switching at least one service column to the offline mode and switching at least one offline column to the service mode and repeating steps (a) to (c) multiple times in order to achieve steady-state leakage of the divalent cations in the water exiting the service column,
wherein the number of divalent ions in the water exiting the service column is not greater than 10% of the number of divalent cations in the feedwater entering the service column.
